(19) United States
(12) Patent Application Publication
(10) Pub. No.: US 2021/0304494 A1
(43) Pub. Date: Sep. 30, 2021

(54) IMAGE PROCESSING APPARATUS, 3D DATA GENERATION APPARATUS, CONTROL PROGRAM, AND RECORDING MEDIUM

(71) Applicant: Sharp Kabushiki Kaisha, Sakai City, Osaka (JP)

(72) Inventors: Tomoyuki YAMAMOTO, Sakai City (JP); Kyohei IKEDA, Sakai City (JP)

(21) Appl. No.: 17/266,170

(22) PCT Filed: Aug. 7, 2019
(86) PCT No.: PCT/JP2019/031151

§ 371 Date: Feb. 5, 2021

(30) Foreign Application Priority Data
Aug. 10, 2018 (JP) 2018-151487

(51) Int. Cl. G06T 17/10; G06T 7/55; G06T 15/20

(52) U.S. Cl. CPC G06T 17/10; G06T 15/205; G06T 7/55

(57) ABSTRACT

An object of the present invention is to generate and reconstruct a 3D model and an image by depth data that includes depths of different types. An image processing apparatus (2) includes: an obtaining unit (7) configured to obtain depth data including multiple input depths of different types, the input depths indicating a three-dimensional shape of an imaging target; and a 3D model generation unit (9) configured to generate a 3D model with reference to at least one of the multiple input depths of different types included in the depth data obtained by the obtaining unit.

### TECHNICAL FIELD

One aspect of the present invention relates to an image processing apparatus, a display apparatus, an image processing method, a control program, and a recording medium that generate a 3D model by depth data including different types of depths.

### BACKGROUND ART

In the field of CG, the approach called DynamicFusion, in which a 3D model (three-dimensional model) is constructed by integrating input depths, has been studied. A main purpose of DynamicFusion is to construct a 3D model where noise is removed in real time from the captured input depth. With DynamicFusion, an input depth obtained from a sensor is integrated into a common reference 3D model after compensation for deformation of a three-dimensional shape. This allows the generation of a precise 3D model from low resolution and high noise depths.

PTL 1 discloses a technology for outputting an image of an arbitrary view point by inputting multi-view color images and multi-view depth images corresponding to the multi-view color images in pixel level.

### CITATION LIST

### Patent Literature

PTL 1: JP 2013-30898 A

### SUMMARY OF INVENTION

### Technical Problem

However, the related art as described above has a problem in that the type of depth data utilized is limited in a system that receives the depth data to construct the 3D model, and the depth data cannot be constructed by using a depth of type that is consistent with the imaging target and meets the user's request.

Even in a case that the depth data includes multiple depths, the depth type cannot be easily determined on the reconstruction apparatus side, and it is difficult to use the depth type in order to improve the quality of the 3D model and meet the user's request.

The present invention has been made in view of the problems described above, and an object of the present invention is to generate and reconstruct a 3D model and an image by depth data including depths of different types.

### Solution to Problem

In order to solve the above-described problem, an image processing apparatus according to an aspect of the present invention includes: an obtaining unit configured to obtain depth data including multiple input depths of different types, the multiple input depths indicating a three-dimensional shape of an imaging target; and a 3D model generation unit configured to generate a 3D model with reference to at least one of the multiple input depths of different types included in the depth data obtained by the obtaining unit.

In order to solve the above-described problem, a 3D data generation apparatus according to an aspect of the present invention is an apparatus for generating 3D data and includes: an image obtaining unit configured to obtain multiple depth images from an imaging device; and a depth data configuration unit configured to configure, with reference to an input user request, depth data by using at least one of the multiple depth images obtained by the image obtaining unit.

### Advantageous Effects of Invention

According to one aspect of the invention, a 3D model and an image are generated and reconstructed by depth data that includes depths of different types.

### BRIEF DESCRIPTION OF DRAWINGS

FIG. 1 is a schematic diagram for describing a general description of Embodiment 1 of the present invention.

FIG. 2 is a block diagram illustrating a configuration of a display apparatus according to Embodiment 1 of the present invention.

FIG. 3 is a schematic diagram for describing a general description of Embodiment 1 of the present invention.

FIG. 4 is a diagram for describing depth information of Embodiment 1 of the present invention.

FIG. 5 is a diagram illustrating an example of a configuration of depth data that is processed by an image processing apparatus according to Embodiment 1 of the present invention.

FIG. 6 is a diagram illustrating an example of a configuration of depth data that is processed by the image processing apparatus according to Embodiment 1 of the present invention.

FIG. 7 is a diagram illustrating an example of a configuration of depth data that is processed by the image processing apparatus according to Embodiment 1 of the present invention.

FIG. 8 is a block diagram illustrating a configuration of a 3D model generation unit according to Embodiment 1 of the present invention.

FIG. 9 is a diagram for describing derivation of a 3D point group corresponding to a depth and depth integration by the 3D model generation unit according to Embodiment 1 of the present invention.

FIG. 10 is a diagram illustrating an example of a configuration of depth data that is referred to by the 3D model generation unit according to Embodiment 1 of the present invention.

FIG. 11 is a block diagram illustrating a configuration of the 3D model generation unit according to a modification of Embodiment 1 of the present invention.

FIG. 12 is a diagram illustrating an example of a configuration of depth data that is referred to by the 3D model generation unit according to a modification of Embodiment 1 of the present invention.

FIG. 13 is a diagram illustrating an example of a configuration of depth data that is referred to by the 3D model generation unit according to a modification of Embodiment 1 of the present invention.

FIG. 14 is a diagram illustrating an example of a configuration of depth data that is referred to by the 3D model generation unit according to a modification of Embodiment 1 of the present invention.

FIG. 15 is a diagram for describing depth that is referred to by the 3D model generation unit according to a modification of Embodiment 1 of the present invention.

FIG. 16 is a block diagram illustrating a configuration of a reconstruction unit included in an image processing apparatus according to Embodiment 2 of the present invention.

FIG. 17 is a block diagram illustrating a configuration of a 3D data generation apparatus according to Embodiment 3 of the present invention.

### DESCRIPTION OF EMBODIMENTS

Embodiments of the present invention will be described below in detail.

### Embodiment 1

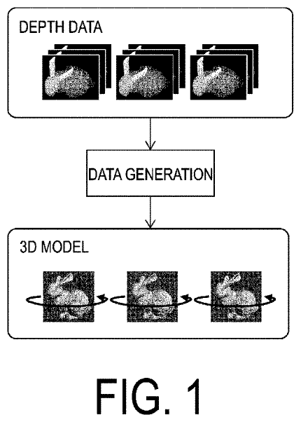

First, a general description of Embodiment 1 of the present invention will be described with reference to FIG. 1. FIG. 1 is a schematic diagram for describing a general description of Embodiment 1 of the present invention. The following steps (1) to (3) are performed as main steps performed by an image processing apparatus according to Embodiment 1.

(1) The image processing apparatus obtains depth data including depths of different types.

(2) The image processing apparatus references the obtained depth data to generate data for extracting a specific type of depth.

(3) The image processing apparatus extracts and utilizes the depth type from the data configured in (2) to generate a 3D model.

### Image Processing Apparatus

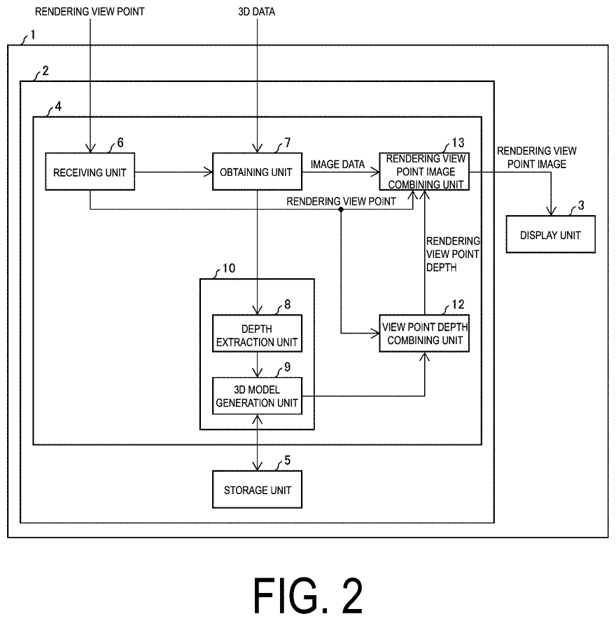

An image processing apparatus 2 according to the present embodiment will be described in detail with reference to FIG. 2. FIG. 2 is a block diagram illustrating a configuration of a display apparatus 1 according to the present embodiment. As illustrated in FIG. 2, the display apparatus 1 includes the image processing apparatus 2 and a display unit 3. The image processing apparatus 2 includes an image processing unit 4 and a storage unit 5, and the image processing unit 4 includes a receiving unit 6, an obtaining unit 7, a reconstruction unit 10, a view point depth combining unit 12, and a rendering view point image combining unit 13.

The receiving unit 6 receives a rendering view point (information related to the rendering view point) from the outside of the image processing apparatus 2.

The obtaining unit 7 obtains 3D data including depth data indicating a three-dimensional shape. The depth data includes multiple input depths of different types and associated information of the input depths represented by camera parameters. The 3D data may additionally include image data of an imaging target. Note that the term “image data” in the specification of the present application indicates an image obtained by capturing a subject from a specific view point. The images herein include still and moving images. The types of input depths will be described later.

The reconstruction unit 10 includes a depth extraction unit 8 and a 3D model generation unit 9.

The depth extraction unit 8 receives 3D data from the obtaining unit 7, and extracts multiple input depths at each time from the 3D data and camera parameters. The extracted depths at each time and camera parameters are output to the 3D model generation unit 9.

The 3D model generation unit 9 generates a 3D model with reference to at least one of the multiple input depths of different types and the camera parameters received from the depth extraction unit 8. Here, the 3D model is a model representing the 3D shape of the subject, and is a model of a mesh representation as one form. In particular, a 3D model without color information is also referred to as a colorless model.

The view point depth combining unit 12 references the rendering view point received by the receiving unit 6 and the 3D model generated by the 3D model generation unit 9 to synthesize a rendering view point depth, which is a depth from the rendering view point to each portion of the imaging target.

The rendering view point image combining unit 13 synthesizes a rendering view point image showing the imaging target from the rendering view point with reference to the rendering view point received by the receiving unit 6, the image data obtained by the obtaining unit 7, and the rendering view point depth synthesized by the view point depth combining unit 12.

The display unit 3 displays the rendering view point image synthesized by the rendering view point image combining unit 13.

The storage unit 5 stores the 3D model generated by the 3D model generation unit 9.

### Image Processing Method

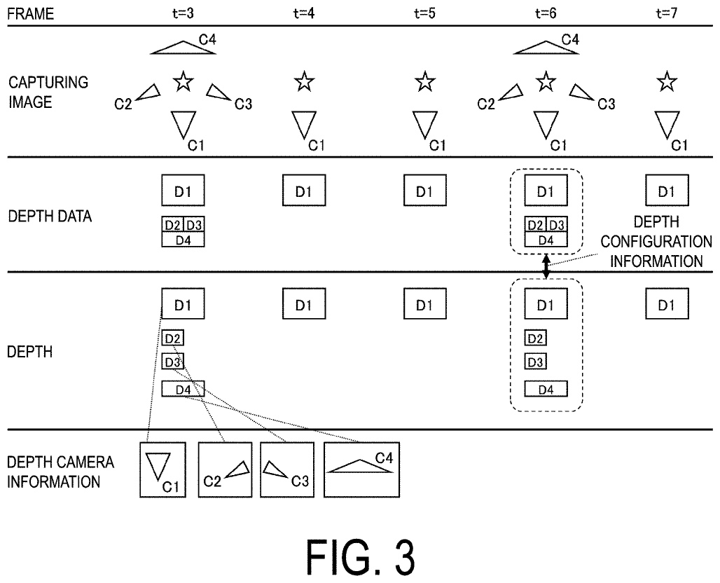

An image processing method by the image processing apparatus 2 according to the present embodiment will be described with reference to FIG. 3. FIG. 3 illustrates capturing images, depth data, depth, and depth camera information, per frame.

Each star symbol of each capturing image is the imaging target, and the triangular marks with C1 to C4 indicate capturing regions with imaging devices (cameras) for capturing the imaging target. In frame t=3, an image composed of D1, and images composed of D2 to D4 of the depth data are depth images obtained by the cameras C1 to C4 in the capturing image. The depth data includes the following information.
Depth image: Image with a depth value assigned to each pixel, 0 to Nd images for each time
Depth information: Configuration and additional information of depth image for each time

The depth information includes the following information.
Number of depth images
Depth portion image information

The depth portion image information includes the following information.
Depth portion image region: Position in depth image
Position and pose of the camera: spatial position and pose of the camera corresponding to the depth portion image
Depth type information

“Camera pose” refers to the direction in which the camera is oriented and is expressed, for example, by a vector representing a camera direction in a specific coordinate system, or an angle of the camera direction with respect to a reference direction.

The depth type information includes the following information.
Main screen flag
View point group identification information
Rendering method
Projection type
Sampling time

The depth type information may include at least one of a main screen flag, a view point group identification information, a rendering method, a projection type, or a sampling time.

The depth information may be configured to be delivered not only in a frame unit for each time point but also in a sequence unit or a unit of a prescribed time period and to be transmitted to a decoder that decodes an image from an encoder that encodes the image. The depth information received in a sequence and a prescribed time period unit may be configured to be specified for each frame.

The depths D1 to D4 are each a depth extracted from the depth image of the depth data.

The pieces of depth camera information C1 to C4 in FIG. 3 are information of spatial positions and poses of the cameras extracted from the depth data, and C1 to C4 respectively correspond to the respective depths D1 to D4.

The depth data is configured by the depth data configuration unit 44 included in the 3D data generation apparatus 41 described below, and is transmitted by the 3D data generation apparatus 41 as 3D data including the depth data. The transmitted 3D data is obtained by the obtaining unit 7 of the image processing apparatus 1. Examples of configurations of the depth data are described below.

### Depth Data Configuration Example: Frame Unit

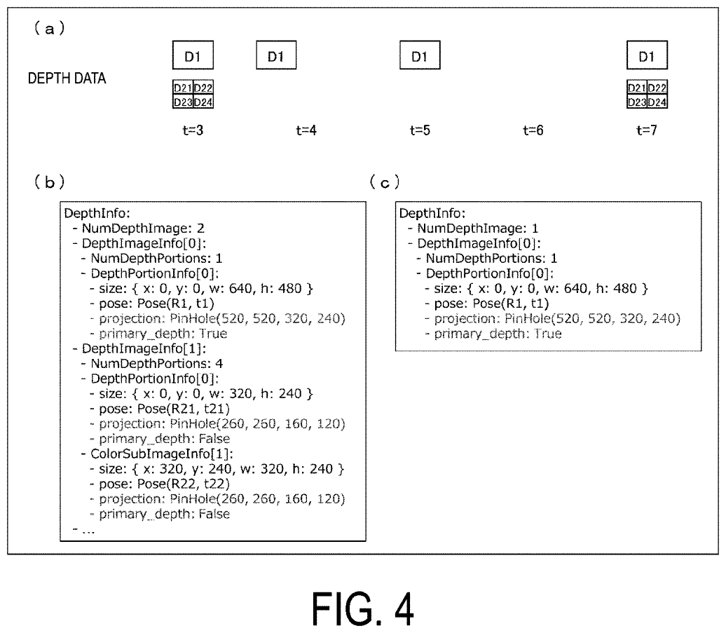

The depth data obtained by the obtaining unit 7 may be different for each frame unit. FIG. 4(a) illustrates a configuration example of depth data, FIG. 4(b) illustrates depth information in the frame t=3, and FIG. 4(c) illustrates depth information in the frame t=5.

The depth data configuration of the present example will be described with reference to the depth data at t=3 illustrated in FIG. 4(a) and depth information in FIG. 4(b).
NumDepthImage: 2

indicates the number of depth images included in the depth data. Here, the number of depth images refers to the total of two depth images, including one depth image including depth D1, and one depth image including depth D21, D22, D23 and D24.
DepthImageInfo [0]:

refers to a depth image that includes the depth D1 and
NumDepthPortions: 1

indicates the number of depths to which DepthImageInfo [0] is assigned and which are included in the depth image. NumDepthPortions is “1” because only depth D1 is included in the depth image.
DepthPortionInfo [0]:

represents depth information for depth (here depth D1) included in the depth image, and
size: x: 0, y: 0, w: 640, h: 4801

indicates that the region corresponding to depth D1 in the depth image is the region of the w*h pixels with the coordinates (x, y) being at the top left.
pose: Pose (R1, t1)

indicates the camera position and pose, and is represented by displacement t1 from a reference position, and rotation R1 from a reference pose.
projection: PinHole (520, 520, 320, 240)

indicates that the projection type is a projection with a pinhole camera model, and the numbers indicate camera internal parameters. Here, the camera internal parameters are fx=fy=520, cx=320, and cy=240.
primary_depth: True

is the main screen flag, and indicates that in a case that the main screen flag is True, then the depth appears on the main screen, and in a case that the main screen flag is False, then the depth image does not appear on the main screen. Here, the main screen is a screen used preferentially in the application, and corresponds to, for example, a screen displayed by the display unit 3 of the display apparatus 1 in a case that the user does not explicitly indicate a rendering view point.

Similarly
DepthImageInfo [1]:

refers to a depth image that includes depths D21, D22, D23 and D24, and
NumDepthPortions: 4

is “4” because the depth image assigned with DepthImageInfo [1] includes the four depths D21, D22, D23 and D24. The following depth information is similar to the information of the depth image including D1, and thus description thereof is omitted.

### Depth Data Configuration Example: Spatial Alignment

The depth data obtained by the obtaining unit 7 includes multiple input depths of different types in association with each of multiple regions on the depth image. For example, the types of input depth are distinguished by four rectangular regions on the depth image, and the depth data is configured such that depths of the same type fall within a rectangular region on the depth image. Each type of input depth is categorized, for example, depending on the view point of the camera, the direction in which the camera is facing, whether the depth is for the generation of a base model, or whether the depth is for generation of a detailed model.

In this way, by using depth data having a configuration in which multiple input depths of different types are associated with respective multiple regions on a depth image, it is possible to easily extract and process a specific type of depth for each region depending on the purpose, so processing is unnecessary to extract all depth portion images, and the effect of reducing the amount of processing is achieved.

The size, number, and the like of the multiple regions are not particularly limited to any configuration, but is preferably configured for each unit in which the depth from the encoded data can be extracted. For example, it is preferable that the multiple regions be rectangular regions and each region be configured as a tile. In this way, a rectangular region is caused to coincide with a tile in the video coding (e.g., High Efficient Video Coding (HEVC)), and decoding the tile only allows a depth portion image group to be extracted, thus reducing the amount of processing data and the processing time compared to decoding the entire image. For example, the multiple regions may be slices in the video coding.

The 3D model generation unit 9 may derive each type of input depth included in the depth data.

As described above, the type of each input depth is a type divided by, for example, a view point of a camera, a direction in which a camera is facing, whether the depth is for generation of a base model, or whether the depth is for generation of a detailed model, and the 3D model generation unit 9 derives which type(s) of depth is included in the depth data.

With such a configuration, the type of input depth included in the depth data can be determined and a specific type of input depth can be utilized for the 3D model generation.

The 3D model generation unit 9 may derive corresponding information indicating the association between the type of input depth and the region on the depth image. For example, in a case that the depth data is configured such that input depths of the same type fall within a rectangular region on the depth image, the corresponding information indicates which type of depth is contained in which rectangular region.

With such a configuration, it is possible to determine which type of input depth corresponds to which region on the depth image.

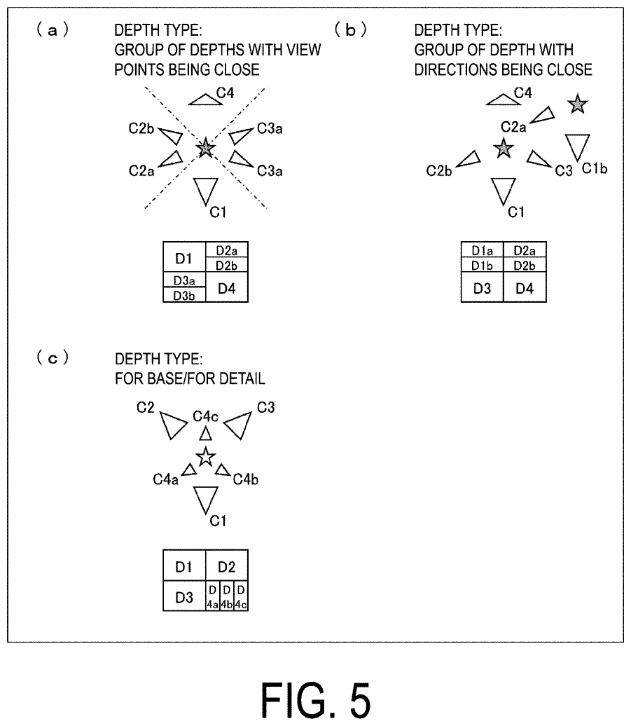

Depth types and depth data configuration examples will be described below. FIG. 5 illustrates an example in which depth data is configured in accordance with space. Each filled star symbol in FIG. 5 is the imaging target, and each graphic indicated by a triangle is a camera that captures the imaging target. FIG. 5(a) is an example of a configuration of depth data in a case that the space is divided into four equal portions, and depths of cameras that are close in view point are considered to belong to the same group. For example, because the spatial positions of cameras C2a and C2b are close and the view points of the cameras are close, depths D2a and D2b corresponding to the cameras C2a and C2b respectively are configured to belong to the same group of depths. The 3D model generation unit 9 determines that the type of input depth of the present example belongs to a group of depths with the camera view point being close, and determines that the cameras C2a and C2b with close camera view points correspond to the respective regions of the depth D2a and D2b in the region of the depth data.

FIG. 5(b) is an example of a configuration of depth data in a case that depths having close directions in which the cameras are facing are considered to belong to the same group. For example, cameras C1a and C1b are facing in the same direction although the imaging targets are different, and depth D1a and D1b corresponding to the cameras C1a and C1b respectively are configured to belong to the same group of depths.

FIG. 5(c) is an example of a configuration of depth data in which depth includes two types of depth including depths for generation of a base model and depths for generation of a detail model, and the depths for generation of the detail model are considered to belong to the same group. For example, because the cameras C4a, C4b, and C4c are all depths for generation of a detailed model, the depths D4a, D4b, and D4c corresponding to C4a, C4b, and C4c are considered to belong to the same group of depths. The depth for generation of a base model is a depth for generating a general model of the imaging target, and the depth for generation of a detail model is a depth for generating details of the imaging target as a 3D model, the depth compensating for the shape information which is lacking in a case that only the depth for generation of the base model is used.

### Depth Data Configuration Example: Time Alignment

The depth data obtained by the obtaining unit 7 is configured such that multiple input depths of different types do not change the mapping between the type of input depth and the region on the depth image in a prescribed time period. For example, the depth data is configured such that the spatial configuration of the type of input depth does not change in a prescribed time period.

By using depth data having such a configuration, in a case of using a module that processes depth data in a time period unit, it is possible to select and input depth data that corresponds to only a specific depth type, so the amount of processing in the module is reduced. The module is, for example, a decoder that decodes coding data.

For example, in a case that a depth image is decoded by using a decoder that decodes coding data in which random access is configured at a fixed interval, and in a case that the spatial configuration of the depth type does not change, it is possible to select and decode the depth data of the random access interval corresponding to the depth type.

The 3D model generation unit 9 may derive the type of each input depth included in the depth data similarly to Depth Data Configuration Example: Spatial Alignment described above.

As described above, the type of each input depth is a type distinguished based on, for example, a view point of a camera, a direction in which a camera is facing, whether the depth is for generation of a base model, or whether the depth is for generation of a detailed model, and the 3D model generation unit 9 derives which type(s) of depth is included in the depth data.

With such a configuration, the type of input depth included in the depth data can be determined and a specific type of input depth can be utilized for the 3D model generation.

The 3D model generation unit 9 may derive corresponding information indicating the mapping between the type of input depth and the region on the depth image. Here, the corresponding information indicates the region to which the type of depth input corresponds, the region being on the depth image in a prescribed time interval unit.

With such a configuration, it is possible to determine which type of input depth corresponds to which region on the depth image.

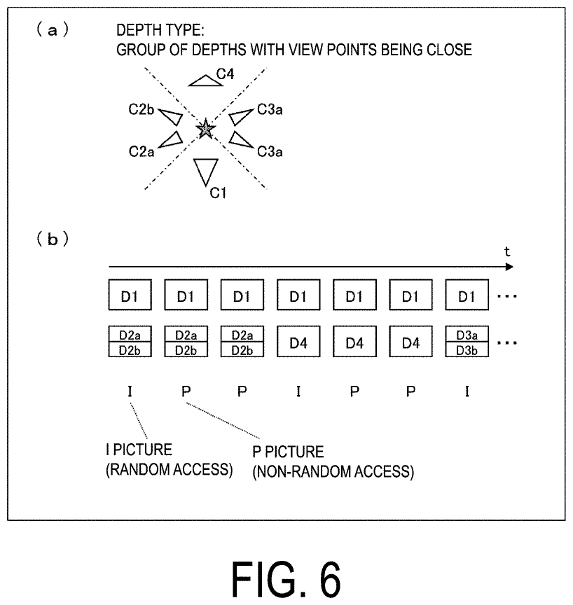

FIG. 6 illustrates an example in which depth data is configured in accordance with time period. FIG. 6(a) illustrates a spatial configuration of a depth type, and FIG. 6(b) illustrates a configuration of depth data in a random access Group of Pictures (GOP) interval. Normally, in a case that an image is encoded, an I picture that allows random access in a fixed time interval and a P picture that allows no random access are periodically arranged. In the present example, the spatial configuration of depth type is not caused to change in an interval from an I picture that allows random access to a next I picture. From the first I picture in FIG. 6(b) to a picture that is one picture before the second I picture, the depth data includes a depth image including the depth D1 corresponding to the camera C1 in FIG. 6(a) and depth images including depths D2a and D2b corresponding to the cameras C2a and C2b. From the second I picture, the depth data includes a depth image including the depth D1 and a depth image including the depth D4, and the depth data is updated. The 3D model generation unit 9 determines that the type of input depth of the present example is a group of depths with the camera view points being close, and determines that, from the first I picture to the picture that is one picture before the second I picture, the cameras C2a and C2b with the camera view points being close correspond to the regions of the depths D2a and D2b in the region of the depth data.

### Depth Data Configuration Example: Arrangement of Depth Information According to Type

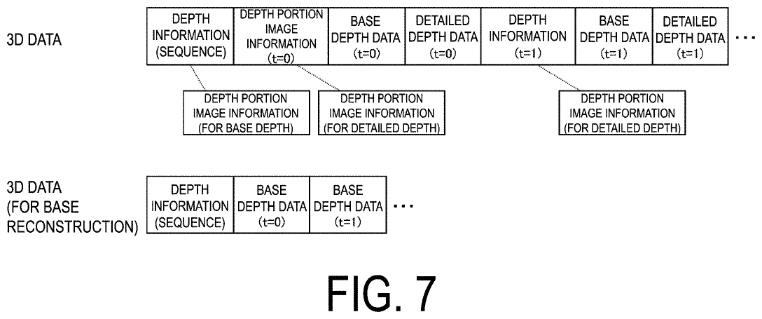

In the depth data obtained by the obtaining unit 7, depth information is allocated at different positions, such as a sequence unit, a GOP unit, and a frame unit, depending on the type of depth. That is, the unit for transmission is different depending on the type of depth. As a method of arrangement as an example, depth information of a basic type of depth is allocated in a long time period (e.g., a sequence unit) and depth information of other types of depth is allocated in a short time period (e.g., in a frame unit). FIG. 7 illustrates an example in which depth information is allocated according to the type of depth.

The 3D data illustrated in an upper part of FIG. 7 is the depth data obtained from the 3D data generation apparatus 41, and the depth data stores depth information, base depth data, and detailed depth data at different positions for each type.

As illustrated in FIG. 7, the number of depths for the generation of a base model, which are of a basic type of depth, and the camera pose are fixedly allocated as sequence unit information. The number of depths for the generation of a detailed model and the camera pose may be changed and allocated for each frame. In other words, as illustrated in FIG. 7, depth information base depth data, and detailed depth data at a frame t=0, may store information different from depth information, base depth data, and detailed depth data at a frame t=1.

The 3D data illustrated in a lower part of FIG. 7 (for base reconstruction) is depth data for the generation of a base model, and is depth information obtained by extracting depth information in a sequence unit and depth information from the upper 3D data.

In this manner, depth information is allocated in different positions, such as a sequence unit, GOP unit, and frame unit, depending on the type of depth, depths for a base model can be combined based on the depth information of the sequence units, and the 3D model generation unit 9 can generate a general shape of the 3D model with a small amount of processing. Therefore, the 3D model can be reconstructed by a reconstruction terminal having low processing performance, and the 3D model can be reconstructed at high speed.

The depth information to be applied to a long interval may be configured to be included in a system layer, such as, for example, content Media Presentation Description (MPD) corresponding to MPEG-DASH, and the depth information to be applied to a short interval may be configured to be included in information of a coding layer, such as, for example, Supplemental Enhancement Information (SEI). By configuring the depth data in this way, it is possible to extract information required for base model reconstruction at the system level.

### 3D Model Generation Unit

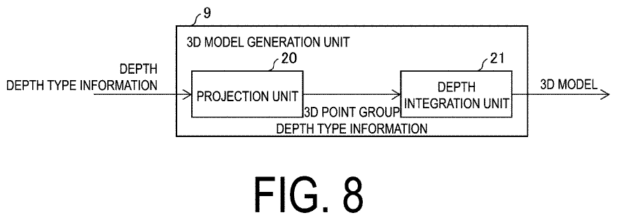

FIG. 8 illustrates a block diagram of the 3D model generation unit 9. As illustrated in FIG. 8, the 3D model generation unit 9 includes a projection unit 20 and a depth integration unit 21. The depth and depth type information are input to the projection unit 20. The projection unit 20 converts each input depth into a 3D point group with reference to the depth type information, and outputs a 3D point group and the depth type information to the depth integration unit 21. The depth integration unit 21 generates and outputs a 3D model at each time by integrating multiple 3D point groups input from the projection unit 20 with reference to the depth type information. Here, the 3D model is a model that includes at least the shape information of the subject, and is a model of a mesh representation (a colorless model) that does not have color information as one form. Specific processing performed by the projection unit 20 and the depth integration unit 21 will be described below.

### 3D Point Group Derivation Procedure and Depth Integration Procedure (1)

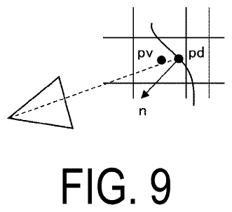

FIG. 9 is a diagram for describing the derivation of a 3D point group corresponding to a depth and depth integration. First, in the projection unit 20, the following is performed, for each pixel constituting a corresponding depth, on the depth.
The pixel positions (u, v) of the target pixel and the depth value recorded in the pixel are converted to three-dimensional spatial coordinates (x, y, z), and the 3D spatial position is derived.
The 3D spatial position in the camera coordinate system is converted to a 3D spatial position in the global coordinate system by using the camera pose direction corresponding to the depth image.

In the depth integration unit 21, the 3D point group is integrated by using depth type information in the following procedure.

(S1) Divide the space into cubic voxel units and zero TSDF/weight_sum in voxel units. TSDF: The Truncated Signed Distance Function indicates the distance from the surface of the object.

(S2) Perform (S3) for each three point group corresponding to each depth of the multiple depths.

(S3) Perform (S4) for each point (x, y, z) included in the target 3D point group.

(S4) Update TSDF and weight of voxels including the target 3D point group.

weight=1.0*α*β
α: angle difference between the camera optical axis and the normal 0<=α<=1, the greater the angle difference is, the smaller the value is
β: distance on a plane perpendicular to the 3D point and the voxel center normal 0<=β<=1, the closer the distance is, the larger the value is

TSDF=TSDF+trunc(n·(pd−pv))*weight
n: normal to target 3D point
pd: spatial position of target 3D point
pv: voxel center position
trunc( ): clip by defined distance
that is, the value corresponding to the distance of the voxel center from the target 3D point along the normal is added to TSDF.

weight_sum=weight_sum+weight

(S5) Divide each voxel TSDF by weight_sum.

### 3D Point Group Derivation Procedure and Depth Integration Procedure (2)

Another example of a depth integration procedure performed by the depth integration unit 21 is given. For example, depth integration is performed in the following procedure.

(S1) Zero TSDF/weight in voxel units.

(S2) Perform (S3) for each three point group corresponding to each depth of the multiple depths.

(S3) Perform (S4) for each point (x, y, z) included in the target 3D point group.

(S4) Update TSDF and weight of voxels including the target 3D point.

weight=1.0*α*β

TSDF=(TSDF*weight_sum+trunc(n·(pd−pv))*weight)/(weight_sum+weight)

weight_sum=weight_sum+weight

Depth Type: Primary View point/Secondary View point Depth

The depth type included in the depth data will be described. The depth data of the present example includes a primary view point depth, which is a depth corresponding to an important view point position (primary view point) during 3D model reconstruction, and other secondary view point depths other than the primary viewpoint depth. An important view point position is, for example, a defined view point position during 3D model reconstruction, or an initial view point position. In the present example, the depth integration unit 21 processes the primary view point depth more preferentially than the secondary view point depth during the 3D model generation.

In this manner, during the 3D model generation, the depth integration unit 21 processes the primary view point depth more preferentially than secondary view point depths, and thereby it is possible to produce, with low delay, a 3D model with high quality in a case of being viewed from near the primary view point.

One Example of Processing Procedure (1)

The processing procedure of the present example is as follows.
The depth integration unit 21 generates and presents a 3D model by using only the primary view point depth.
Next, the depth integration unit 21 generates a 3D model by using the primary view point depth and secondary view point depths and replaces the presented 3D model with the generated 3D model.

Since the extent to which the view point can move is limited in a case that the primary view point is the initial view point, quality degradation is small even in a case that the 3D model is generated only by the primary view point depth that is deep in relation to the 3D model seen from the primary view point.

### One Example of Processing Procedure (2)

The depth integration unit 21 generates a 3D model with the primary view point depth more preferentially than secondary view point depths.
For example, either the primary view point depth or the secondary view point depth is added to weight in the integration process described in 3D Point Group Derivation Procedure and Depth Integration Procedure (1) and 3D Point Group Derivation Procedure and Depth Integration Procedure (2), to make the weight larger in a case of the primary view point depth.

In this way, by prioritizing the primary view point depth, it is possible to generate a high quality 3D model in a case of being viewed from the primary view point.

Without explicitly sending identification information of the primary view point/secondary view point depth, the depth of the region including the top left pixel of the first depth in the decoding order may be considered to be the primary view point depth and other depths may be considered to be the secondary view point depths.

In this way, by predetermining the regions of the primary view point depth and the secondary view point depths, there is no need to read additional information, and by using a depth earlier in the decoding order, a 3D model can be generated with a smaller delay.

### Depth Type: Base/Detailed Depth

The depth data of the present example includes a depth for generation of a base model and a depth for generation of a detailed model. Hereinafter, the depth for generation of the base model is also referred to as a base depth, and the depth for generation of the detailed model is also referred to as a detailed depth. The base depth data corresponds to a depth image taken from a fixed or continuously changing view point position. The detailed depth data may take a different view point and a different projection parameter at each time.

In this way, by the base depth and the detailed depth being included in the depth data, it is possible to reconstruct the base depth as a greyscale video and confirm the imaging target without performing 3D model integration. The base depth data can be readily utilized for other applications, such as segmentation of color images. The detailed depth can also compensate for shape information which is lacking in a case that the base depth only is used and improve the quality of the 3D model.

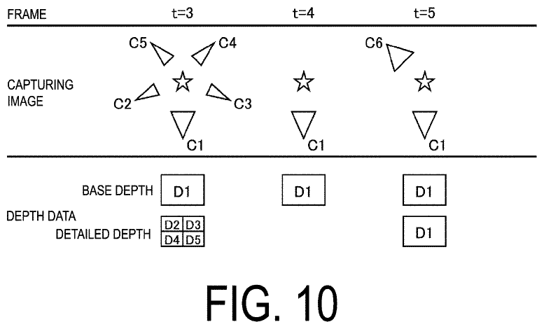

FIG. 10 illustrates a capturing image for each frame and depth data in a case that the depth data includes a base depth and a detailed depth. As illustrated in the capturing image in FIG. 10, the camera C1 is in a fixed position even in a case that the frame changes, and the base depth D1 corresponding to the camera C1 is also fixed. In contrast, cameras other than the camera C1 change in number and position per frame, and detailed depths D2 to D6 corresponding to the cameras C2 to C6 other than the camera C1 change with frame.

### Modifications

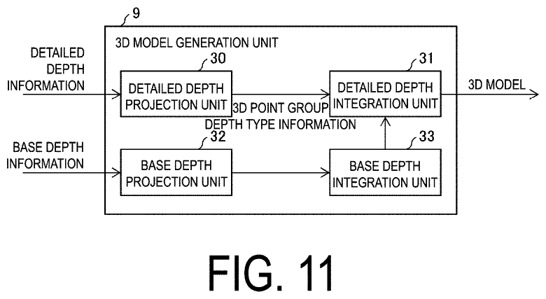

A modification of the 3D model generation unit 9 will be described. FIG. 11 is a block diagram illustrating a configuration of the 3D model generation unit 9 according to the present modification. As illustrated in FIG. 11, the 3D model generation unit 9 includes a detailed depth projection unit 30, a detailed depth integration unit 31, a base depth projection unit 32, and a base depth integration unit 33.

The base depth projection unit 32 converts an input base depth to a 3D point group with reference to depth type information and outputs the result to the base depth integration unit 33.

The base depth integration unit 33 integrates multiple input 3D point groups with the depth type information to generate a base model, and outputs the base model to the detailed depth integration unit 31.

The detailed depth projection unit 30 converts the input detailed depth to a 3D point group with reference to the depth type information and outputs the result to the detailed depth integration unit 31.

The detailed depth integration unit 31 integrates the 3D point group input from the detailed depth projection unit 30, the depth type information, and the 3D point group input from the base depth integration unit to generate and output a 3D model.

### Depth Type: Depth Range

In the present example, an example is described in which the depth data includes depths having different depth ranges.

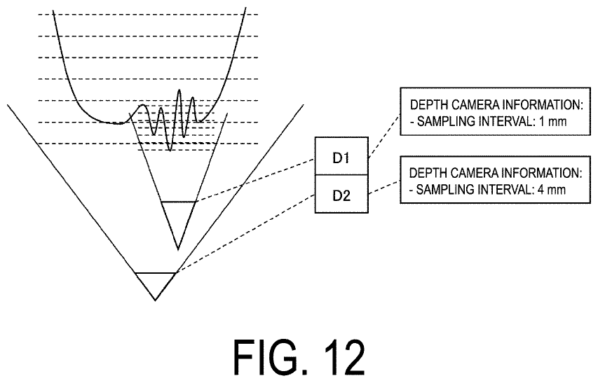

FIG. 12 is a diagram illustrating depth data in a case that two cameras having different resolutions, that is, depth ranges, capture images. As illustrated in FIG. 12, D1 is a depth with a sampling interval of 1 mm and D2 is a depth with a sampling interval of 4 mm Regions where the angles of view points of the two cameras corresponding to D1 and D2 overlap can obtain a depth of a detailed shape of the imaging target that cannot be obtained by using only a camera corresponding to D2.

In this manner, the depth data includes depths having different depth ranges, thereby the 3D model generation unit 9 can create wide range shape information for the imaging target as a depth image with a wide range of depth values, and create narrow range shape information as a narrow range depth image. In this way, it is possible to generate a 3D model that replicates the general shape and the shape details of the specific region.

The method of using the base depth and the detailed depth described with reference to FIG. 11 and the method of using different depth ranges may be used in combination. Specifically, a fixed wide range of depth values is used in the base depth and a variable narrow range of depth values is used in the detailed depth, and thereby it is possible to obtain information of the general shape of the subject in the base depth and obtain information on the shape details of the subject in the detailed depth. In other words, it is possible to express the entire 3D model by using only the base depth, and adding a detailed depth allows scalability for replicating the shape details to be achieved.

### Depth Type: Sampling Time (1)

In the present example, an example is described in which the depth data includes depths of different sampling times. The depth data of the present example includes a depth assigned the same time as the frame and a depth assigned a reference time different from the frame. The depth assigned the same time as the frame is utilized for deformation of the 3D model as a depth for deformation compensation. The depth assigned a reference time different from the frame is utilized for the 3D model generation as a depth for reference model construction.

In this way, for generation of the 3D model, a depth of time at which a 3D model can be generated with high accuracy is selected and deformation is performed by using the depth for deformation compensation, thereby allowing a 3D model with less holes due to occlusion to be generated.

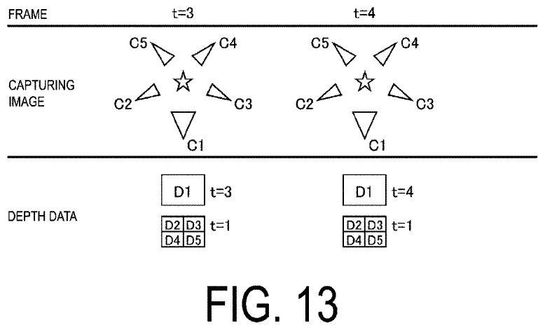

FIG. 13 is a diagram illustrating depth data including a depth assigned the same time as the frame and a depth assigned a reference time different from the frame in the present example. As illustrated in FIG. 13, the depth D1 in the frame t=3 is assigned the same time (t=3) as the frame. In contrast, the depths D2 to 5 are assigned a reference time (t=1) different from the frame. Here, the depth D1 is utilized for deformation of the 3D model, and the depths D2 to 5 are utilized to generate the 3D model.

### Depth Type: Sampling Time (2)

In the present example, an example is described in which the depth data includes depths of different sampling times. The present example is the same with Depth Type: Sampling Time (1) in that the depth data includes a depth assigned the same time as the frame and a depth assigned a reference time different from the frame. A difference is that in the present example, a depth assigned the same time as the frame is used as a depth for primary view point details, and a depth assigned a reference time different from the frame is used as a depth for base. The depth for base is utilized for base model construction in a frame of time consistent with the assigned time.

With Such a configuration, it is possible to distributedly transmit the information required for the model construction even in a case that the band is limited. Even in a case that the information is distributedly transmitted, it is possible to maintain the shape of the 3D model viewed from the primary view point at a high quality.

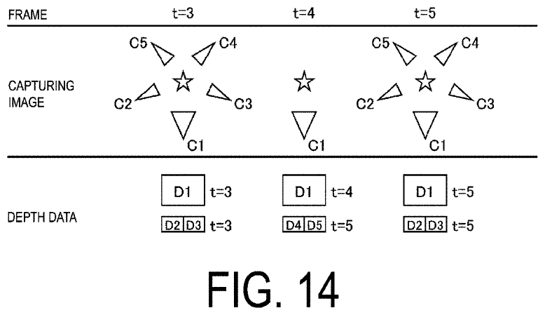

FIG. 14 is a diagram illustrating depth data including a depth assigned the same time as the frame and a depth assigned a reference time different from the frame in the present example. As illustrated in FIG. 14, the depth D1 in the frame t=3 is assigned the same time (t=3) as the frame, and the depths D2 and D3 are also assigned the same time (t=3) as the frame. In contrast, the depth D1 in the frame t=4 is assigned the same time (t=4) as the frame, and the depths D4 and D5 are assigned a reference time (t=5) different from the frame.

### Depth Type: Projection

In the present example, an example in which the depth data includes depths created from different projections will be described. A projection determines mapping between a spatial point and a pixel position of the camera. Conversely, in a case that projections are different, the spatial points corresponding to the pixels differ even though the camera positions are the same and the pixel positions are the same. A projection is determined by a combination of multiple camera parameters, such as, for example, a camera angle of view point, resolution, a projection method (e.g., a pinhole model, a cylindrical projection, or the like), a projection parameter (focal length, position of a center corresponding point of the camera optical axis on the image), and the like.

By appropriately selecting the projection, it is possible to control the range of subjects that can be captured as images even with the same resolution. Therefore, the depth data includes depths created by different projections, thereby allowing the required information on the shape data to be expressed by a small number of depths depending on the arrangement of the imaging target, so the amount of data of the depth data can be reduced.

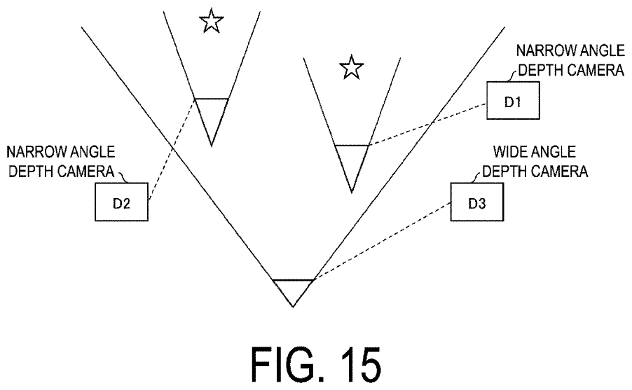

FIG. 15 illustrates a depth created with multiple different projections in the present example. As illustrated in FIG. 15, each star symbol indicates an imaging target, and there are two imaging targets. The depth data of FIG. 15 includes a depth D3 corresponding to a capturing image by a wide angle camera (capturing image by wide angle projection) that projects the entire two imaging targets, and depths D1 and D2 corresponding to capturing images (capturing images by narrow angle projection) corresponding to the capturing images by narrow angle cameras (capturing images by narrow angle projection) that project the respective imaging targets.

In a case that multiple imaging targets are present in the depth data, the depth data includes the depth of the wide angle projection that projects the entire multiple imaging targets and the depths of the narrow angle projections that project the individual imaging target, and thereby it is possible to reconstruct the positional relationship between the imaging targets and the detailed shapes of the individual imaging targets at the same time.

### Embodiment 2

Another embodiment of the present invention will be described below. Note that, for the sake of convenience of description, members having the same functions as the members described in the above embodiment are denoted by the same reference signs, and descriptions thereof will not be repeated.

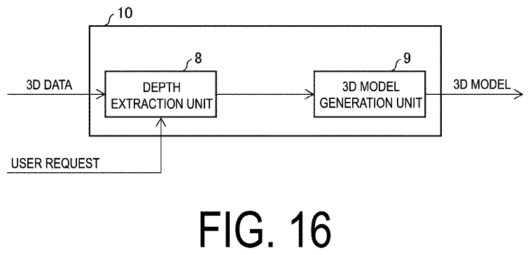

FIG. 16 is a block diagram illustrating a configuration of the reconstruction unit 10 according to the present embodiment. As illustrated in FIG. 16, the reconstruction unit 10 according to the present embodiment includes a depth extraction unit 8 and a 3D model generation unit 9, as in Embodiment 1, but the depth extraction unit 8 receives input of a user request in addition to the 3D data, and the 3D model generation unit 9 further references the user request to generate a 3D model. The user request is, for example, listed below.
View point position, view point direction, and direction of movement
Reconstruction quality (spatial resolution, hole amount, model accuracy, noise amount)
Received data maximum bit rate, minimum bit rate, and average bit rate
Audience attributes (gender, age, height, visual acuity, etc.)
Processing performance (number of depth images, number of depth pixels, number of model meshes, etc.)
Terminal attributes (computer/mobile, OS, CPU type, GPU type, etc.)

In this way, in addition to the 3D data, the user request is utilized to extract depths from the depth data, thereby allowing a 3D model that meets the user request to be generated.

A specific example of a combination of depth type and user request will be described below.

### Combination of Depth Type and User Request: View Point Position

In the present example, the reconstruction unit 10 switches between a 3D model construction (base model construction) using only the base depth and a 3D model construction (detailed model construction) in which the base depth and the detailed depth are combined, in accordance with the user request (view point position). As an example, a base model construction may be applied in a case that the view point position is far from the imaging target, and the detailed model construction may be applied in a case that the view point position is close to the imaging target.

In this way, the depth extraction unit 8 selects and switches between the base model construction and the detailed model construction in accordance with the user's view point position, thereby allowing the amount of reconstruction processing to be reduced in a case that the view point position is far from the subject. As compared to the detailed model, the quality of the base model is low, but in a case that the user's view point position is far, the quality reduction in a case that the view point images are combined is low and thus the base model construction is effective. Conversely, in a case that the view point position is close, a high quality model can be reconstructed by applying the detailed model construction.

The specific procedure of the present example is as follows.
Derive a distance between the specified view point position of the user request and the position of the imaging target
Example of position of the imaging target:
Median value or mean value of the position of a point in the 3D space to which the depth value of the primary depth corresponds
Separately received model representative position
The distance between the view point position and the position of the imaging target and a prescribed threshold value of the distance are compared, and in a case that the distance is less than the threshold value, the detailed model construction is performed, and in a case that the distance is equal to or greater than the threshold value, the base model construction is performed
Example of threshold value:
Calculation from the resolution of the view point image and the resolution of the base depth
Use separately received or prescribed threshold value

### View Point Position of User Request

The view point position of the user request is a view point position required by the user in reconstruction, and need not necessarily be the user view point position at each time. For example, a user may configure a view point position at a prescribed time interval, and configure another view point position as a view point generated at each time.
Example of selecting base model construction and detailed model construction with user request every second with 60 fps depth data

t=60k (k is an integer): select base model construction or detailed model construction at the view point position of t=60k to generate the 3D model and generate a view point image

t=60k+1 to 60k+59: generate a 3D model in a mode selected at t=60k to generate a view point image

A depth having a wide range may be used in place of the base depth and a depth having a narrow range may be used in place of the detailed depth.

### Combined Use of Depth Type and User Request: Device Performance

In the present example, the user request is a view point position and a device performance request, and the reconstruction unit 10 selects the base depth and the detailed depth in response to the user request to generate a 3D model. As an example, the reconstruction unit 10 selects and uses the depth with the highest priority of using the number of depths that the device performance request satisfies, then the base depth, and then depths in order of depth closer to the view point.

With such a configuration, it is possible to construct a high quality 3D model as viewed from the user view point within a range that device performance satisfies.

The specific procedure performed by the reconstruction unit 10 in the present example is illustrated below.
The depth extraction unit 8 determines the number of depths or the number of depth pixels that can be processed, based on the device performance request
Depth selection
Select a base depth in order of depth closer to the view point and end selection once the number of depths or the number of depth pixels is exceeded
Select a detailed depth in order of depth closer to the view point and end selection once the number of depths or the number of depth pixels is exceeded
3D model generation unit 9 constructs 3D model
Integrate selected depths to construct 3D model

Here, the proximity of the depth and the view point is the distance between the representative position of a point of the 3D space corresponding to the depth pixel (average, median value, corresponding point position of the central pixel, etc.) and the view point.

The optical axis direction of the camera corresponding to each depth may be utilized to determine priority as a preference for the selection of the base depth and the detailed depth. Specifically, a depth with a small angle of the vector from the user view point to the depth representative point and the camera optical axis vector (vector from the camera position) may be selected preferentially.

### Embodiment 3

### 3D Data Generation Apparatus

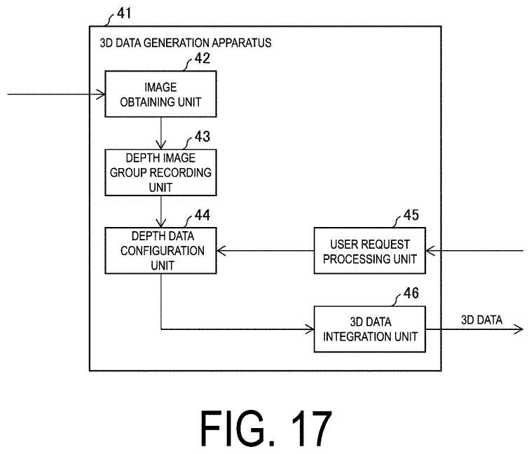

A 3D data generation apparatus according to the present embodiment will be described. FIG. 17 is a block diagram illustrating a configuration of the 3D data generation apparatus according to the present embodiment. As illustrated in FIG. 17, a 3D data generation apparatus 41 includes an image obtaining unit 42, a depth image group recording unit 43, a depth data configuration unit 44, a user request processing unit 45, and a 3D data integration unit 46.

The image obtaining unit 42 obtains multiple depth images input from the imaging device, such as a camera that captures the imaging target. The image obtaining unit 42 outputs the input depth images to the depth image group recording unit 43.

The depth image group recording unit 43 records the depth images input from the image obtaining unit 42. The recorded depth images are output to the depth data configuration unit 44 as appropriate in accordance with a signal from the user request processing unit 45.

The user request processing unit 45 starts processing in accordance with the user request. For example, the following processes are performed by the depth data configuration unit 44 and the 3D data integration unit 46 at each reconstruction time.
The depth data configuration unit 44 references to the user request, and then configures depth data including multiple depths of different types by using at least one of the depth images recorded in the depth image group recording unit 43
The 3D data integration unit 46 integrates the depth data and outputs the result as 3D data

Note that the image obtaining unit 42 does not necessarily need to obtain the depth image for each user request, and may be configured to obtain in advance the depth image that is required and record the depth image in the depth image group recording unit 43.

### Depth Data Generation in Response to User Request: User View Point

In the present example, the depth data configuration unit 44 selects a depth included in the 3D data generated in accordance with the user's view point position, and configures the depth data. Specifically, in a case that the distance between the imaging target and the user is far, the depth data configuration unit 44 configures depth data including many depths that are oriented in the direction of the user in the depths of the imaging target, and relatively a few depths in other directions.

In this way, the depth data configuration unit 44 selects which direction depth to be used as the depth to configure the depth image depending on the user view point position, and thereby it is possible to generate a 3D model with a high quality of the portion observed from the periphery of the user's view point position while suppressing the increase in the amount of data.

A specific example in which the depth data configuration unit 44 configures the depth data will be described.
The depth image group recording unit 43 records a multi-view depth image in three stages (d=1, 3, 5) in a distance to the imaging target in each direction in the horizontal 12 directions (θ=30 degrees*k) with the imaging target at the center.
The depth data configuration unit 44 selects the depth according to the following methods a to c depending on the distance between the user view point and the imaging target. Here, the primary view point depth is a depth that corresponds to an important view point position (primary view point) during 3D model reconstruction, and the secondary view point depth is a depth that corresponds to a view point other than the primary view point.
a) Distance between the user view point and the imaging target is less than 1 Primary view point depth: distance 1, depth in nearest neighbor direction Secondary view point depth: 4 depths in neighbor direction at distance 1
b) Distance between the user view point and the imaging target is less than 3 Primary view point depth: distance 3, depth in nearest neighbor direction

Secondary view point depth: 3 depths of depth in nearest neighbor direction at distance 1+depth in neighbor direction at distance 3
c) Distance between the user view point and the imaging target is equal to or greater than 3

Primary view point depth: distance 5, depth in nearest neighbor direction

Secondary view point depth: 2 depths of depth in nearest neighbor direction at distance 1, 3+depth in neighbor direction at distance 3

### Control of Region for Transmission

In the present example, the user is a content provider, and the depth data configuration unit 44 selects a depth included in the 3D data in response to the request by the content provider to configure the depth data.

In this way, the depth data configuration unit 44 selects a depth that includes 3D data in response to the request by the content provider to exclude depth including specific regions in the 3D model to be reconstructed from 3D data, thereby allowing a 3D model in which the regions are not reproduced to be constructed.

The depth data configuration unit 44 increases depths of the imaging target to be focused by the viewer viewing the reconstructed 3D model, and reduces depths of other imaging targets, and thereby it is possible to reconstruct the 3D model of the imaging target to be focused with high accuracy while maintaining the amount of data.

Examples of specific regions include, but are not limited to, a region where the content creation side does not want to be viewed by a viewer, a region in which viewing is allowed only for a specific user such as classified information, a region determined not to be viewed by a user such as sexual content, violence content, and the like, for example.

### Implementation Examples by Software

The control block of the image processing apparatus 2 (3D model generation unit 9) and the control block of the 3D data generation apparatus 41 (in particular, the depth data configuration unit 44) may be implemented by a logic circuit (hardware) formed in an integrated circuit (IC chip) or the like, or may be implemented by software.

In the latter case, the image processing apparatus 2 and the 3D data generation apparatus 41 include a computer that executes instructions of a program that is software for realizing the functions. The computer includes at least one processor (control apparatus), for example, and includes at least one computer-readable recording medium having the program stored thereon. The processor in the computer reads from the recording medium and performs the program to achieve the object of the present invention. A Central Processing Unit (CPU) can be used as the processor, for example. As the above-described recording medium, a “non-transitory tangible medium” such as a tape, a disk, a card, a semiconductor memory, and a programmable logic circuit, for example, can be used, in addition to Read Only Memory (ROM) or the like. A Random Access Memory (RAM) for deploying the above-described program may be further provided. The above-described program may be supplied to the above-described computer via an arbitrary transmission medium (such as a communication network and a broadcast wave) capable of transmitting the program. Note that one aspect of the present invention may also be implemented in a form of a data signal embedded in a carrier wave in which the program is embodied by electronic transmission.

### Supplement

An image processing apparatus according to a first aspect of the present invention includes: an obtaining unit configured to obtain depth data including multiple input depths of different types, the multiple input depths indicating a three-dimensional shape of an imaging target; and a 3D model generation unit configured to generate a 3D model with reference to at least one of the multiple input depths of different types included in the depth data obtained by the obtaining unit.

An image processing apparatus according to a second aspect of the present invention may be configured such that, in the first aspect, the depth data obtained by the obtaining unit includes the multiple input depths of different types in association with each of multiple regions on a depth image.

An image processing apparatus according to a third aspect of the present invention may be configured such that, in the second aspect, the depth data obtained by the obtaining unit includes the multiple input depths of different types so as not to change a mapping between a type of the different types of the multiple input depths and a region of the multiple regions on the depth image in a prescribed time period.

An image processing apparatus according to a fourth aspect of the present invention may be configured such that, in the second or third aspect, the 3D model generation unit is configured to derive mapping information indicating the mapping between the type of the different types of the multiple input depths and the region of the multiple regions on the depth image.

An image processing apparatus according to a fifth aspect of the present invention may be configured such that, in any one of the first to fourth aspects, the 3D model generation unit is configured to derive a type of the different types for each of the multiple input depths included in the depth data.

An image processing apparatus according to a sixth aspect of the present invention may be configured such that, in any one of the first to fifth aspects, the 3D model generation unit includes a projection unit configured to convert each of the multiple input depths included in the depth data into a 3D point group and a depth integration unit configured to generate a 3D model at each time from the 3D point group, with reference to a type of the different types for an input depth of the multiple input depths.

An image processing apparatus according to a seventh aspect of the present invention may be configured such that, in any one of the first to sixth aspects, the 3D model generation unit is configured to generate a 3D model with further reference to a user request.

A 3D data generation apparatus according to an eighth aspect of the present invention is an apparatus for generating 3D data and includes: an image obtaining unit configured to obtain multiple depth images from an imaging device; and a depth data configuration unit configured to configure, with respect to an input user request, depth data including multiple depths of different types by using at least one of the multiple depth images obtained by the image obtaining unit.

The image processing apparatus according to each of the aspects of the present invention may be implemented by a computer. In this case, the present invention embraces also a control program of the image processing apparatus that implements the above image processing apparatus by a computer by causing the computer to operate as each unit (software element) included in the above image processing apparatus, and a computer-readable recording medium recording the program.

The present invention is not limited to each of the above-described embodiments. It is possible to make various modifications within the scope of the claims. An embodiment obtained by appropriately combining technical elements each disclosed in different embodiments falls also within the technical scope of the present invention. In a case that technical elements disclosed in the respective embodiments are combined, it is possible to form a new technical feature.

### CROSS-REFERENCE OF RELATED APPLICATION

The present application claims priority of JP 2018-151847, filed on Aug. 10, 2018, and all the contents thereof are included herein by the reference.

### REFERENCE SIGNS LIST

2 Image processing apparatus
7 Obtaining unit
9 3D model generation unit
20 Projection unit
21 Depth integration unit
41 3D data generation apparatus
42 Image obtaining unit
44 Depth data configuration unit

1. An image processing apparatus comprising:
an obtaining circuit configured to obtain depth data including multiple input depths of different types, the multiple input depths indicating a three-dimensional shape of an imaging target; and
a 3D model generation circuit configured to generate a 3D model with reference to at least one of the multiple input depths of different types included in the depth data obtained by the obtaining unit.

2. The image processing apparatus according to claim 1, wherein
the depth data obtained by the obtaining circuit includes the multiple input depths of different types in association with respective multiple regions on a depth image.

3. The image processing apparatus according to claim 2, wherein
the depth data obtained by the obtaining circuit includes the multiple input depths of different types so as not to change a mapping between a type of the different types of the multiple input depths and a region of the multiple regions on the depth image in a prescribed time period.

4. The image processing apparatus according to claim 2, wherein
the 3D model generation circuit
derives mapping information indicating the mapping between the type of the different types of the multiple input depths and the region of the multiple regions on the depth image.

5. The image processing apparatus according to claim 1, wherein
the 3D model generation circuit
derives a type of the different types for each of the multiple input depths included in the depth data.

6. The image processing apparatus according to claim 1, wherein
the 3D model generation circuit includes
a projection circuit configured to convert each of the multiple input depths included in the depth data into a 3D point group and
a depth integration circuit configured to generate a 3D model at each time from the 3D point group, with reference to a type of the different types for an input depth of the multiple input depths.

7. The image processing apparatus according to claim 1, wherein
the 3D model generation circuit
generates a 3D model with further reference to a user request.

8. A 3D data generation apparatus for generating 3D data, the 3D data generation apparatus comprising:
an image obtaining circuit configured to obtain multiple depth images from an imaging device; and
a depth data configuration circuit configured to configure, with reference to an input user request, depth data including multiple depths of different types by using at least one of the multiple depth images obtained by the image obtaining unit.

9. A non-transitory computer readable recording medium having recorded thereon a control program causing a computer to operate as the image processing apparatus according to claim 1, wherein
the control program causes the computer to operate as the 3D model generation unit.

10. (canceled)
